(19) United States
(12) Patent Application Publication
(10) Pub. No.: US 2026/0321472 A1
(43) Pub. Date: Oct. 15, 2026

(54) TRANSFORMER FOR USE AT CRYOGENIC TEMPERATURES, USE OF A TRANSFORMER AND METHOD OF PRODUCING A TRANSFORMER FOR USE AT CRYOGENIC TEMPERATURES

(71) Applicant: Airbus SAS, BLAGNAC (FR)

(72) Inventors: Gerhard STEINER, TAUFKIRCHEN (DE); Florian KAPAUN, TAUFKIRCHEN (DE); Christopher DAHMEN, TAUFKIRCHEN (DE)

(21) Appl. No.: 19/643,969

(22) Filed: Apr. 10, 2026

(30) Foreign Application Priority Data
Apr. 11, 2025 (EP) 25170106.6

(51) Int. Cl. H01F 6/06; B64D 27/35; B64D 31/16; B64D 41/00; H01F 27/24; H01F 41/02; H01F 41/04

(52) U.S. Cl. CPC H01F 6/06; B64D 27/35; B64D 31/16; B64D 41/00; H01F 27/24; H01F 41/0206; H01F 41/04; B64D 2221/00

(57) ABSTRACT

To provide a compact lightweight transformer for use at cryogenic temperatures, between 2K and 230K, the transformer includes a ferrite core with an air gap and comprising a relative permeability at 77K, µᵣᵣ

### CROSS-REFERENCES TO RELATED APPLICATIONS

This application claims the benefit of European Patent Application Number 25170106.6 filed on Apr. 11, 2025, the entire disclosures of which are incorporated herein by way of reference.

### FIELD OF THE INVENTION

The present invention relates to a transformer for use at cryogenic temperatures, use of a transformer in a circuit operating at cryogenic temperatures and method of producing a transformer for use at cryogenic temperatures.

### BACKGROUND OF THE INVENTION

For some applications, e.g., driving an electric motor formed of superconductive material, it may be desirable to place some or all of the electronic circuitry for driving the electric motor in the part of the application that is at cryogenic temperatures rather than in the part of the application that is at room temperature.

The published US patent application US 2020/0225301 A1 describes a magnet assembly comprising a superconducting coil, a cryogenic system, a DC voltage source, a SMPS (Switched Mode Power Supply), current leads, and a controller. The cryogenic system comprises a cryostat and is configured to maintain the superconducting coil at an operating temperature below the critical temperature of the superconductor. The DC voltage source is located outside the cryostat. The SMPS is located inside the cryostat and configured to supply power from the DC voltage source to the superconducting coil.

Circuitry that is developed and provides certain functions at room temperature, operates differently at cryogenic temperatures, if at all. It is, therefore, an object of the invention to provide a small, lightweight transformer suitable for use at cryogenic temperatures.

### SUMMARY OF THE INVENTION

According to the invention, a transformer for use at cryogenic temperatures is provided. The transformer comprises a ferrite core with an air gap and comprises a relative permeability at 77K, µᵣᵣ wherein 50 ≤ µr (77K) ≤ 1000, at least one primary winding and at least one secondary winding.

The invention provides a ferrite core-based transformer suitable for applications operating in the cryogenic temperature range. Herein cryogenic temperatures and the cryogenic temperature range is defined as 2K to 230K. The transformer may be operated in a temperature of range of 25K to 150K, which corresponds to the operation range of liquid hydrogen.

The ferrite core-based transformer of the invention minimizes the weight, size and mounting effort for a transformer operated at cryogenic temperatures while taking into account the temperature dependent reduction of the µr value of the ferrite material.

Most power electronics topologies need a minimum primary inductance of the transformer. In a cryogenic environment, the relative permeability µr of ferrite decreases. For some ferrites, the relative permeability µr may even become 0, so that these ferrites are not suitable for use in the transformer according to the invention. Therefore, transformers which operate acceptably at industrial or automotive temperature ranges, e.g., -40°C to 100°C, are not usable in a cryogenic environment due to this reduction in the relative permeability of the ferrite core.

To overcome this issue, a temperature - stable air gap is introduced into the ferrite core to minimize the impact of the reduction in relative permeability and to ensure a minimum and acceptable inductance. Therefore, the design of small, lightweight and easy-to-mount transformers with coil formers for isolated power supplies is provided. These transformers are also suitable for low power ranges. Such compact transformer designs, especially if multiple windings are used, cannot be produced with available wound toroidal or U-shaped cores.

The ratio of the turns of one primary winding to the number of turns of its associated secondary winding may be selected so as to provide the desired step-down or step-up ratio. In an example, the primary winding has 1 turn and the secondary winding 3 turns.

In an embodiment, the ferrite core comprises first and second E-shaped parts with an air gap. In an alternative embodiment, the ferrite core is used in a planar transformer design. For example, the ferrite core comprises a first E-shaped part and a second planar, e.g., cuboid, part.

In an embodiment, the one or more primary windings are formed in a coil former and the one or more secondary windings are formed in a coil former.

In an embodiment for planar transformer designs, the one or more primary windings are formed on or in a circuit board, e.g., a printed circuit board, and the one or more secondary windings are formed on or in the circuit board.

The ferrite material of the core comprises a soft magnetic ferrite. An example of a ferrite material that has a relative permeability at 77K, µr(77K), wherein 50 ≤ µr (77K) ≤ 1000 for the ferrite core is a manganese zinc ferrite. A manganese zinc ferrite comprises an oxide made from iron, manganese and zinc. An example of such a manganese zinc ferrite is the commercially available ferrite available under the trade name N87.

The invention also provides for the use of the transformer of any one of the embodiments described herein in a circuit operating at cryogenic temperatures in the range of 2K to 230K, preferably 25K to 150K.

The invention also provides for the use of the transformer of any one of the embodiments described herein in a circuit operating at temperatures in the range of 25K to 373K.

The circuit may have different topologies. In some embodiments, the circuit comprises an inverter or an AC/AC converter or a power supply or a DC/DC converter or an AC/DC converter or an AC/DC converter with signal transmission. The circuit may be used in applications comprising potential separated information transmission or potential separated energy transmission.

In some embodiments, the circuit is configured to operate at a frequency in the range of 1 kHz to 900 kHz, preferably 100 kHz to 200 kHz. In an embodiment, the circuit is used as an auxiliary power supply and is configured to operate at a frequency in the range of 100 kHz to 200 kHz.

In an embodiment, the circuit comprises a single primary winding and a single secondary winding. Alternatively, the circuit comprises more than one primary winding and more than one secondary winding.

In some embodiments, the circuit comprises multiple outputs. Two or more of the multiple outputs may be coupled to a single primary winding or to more than one primary winding.

The primary winding and secondary winding are electrically isolated from one another. The secondary windings may be coupled to two or more output terminals. The output terminals are electrically isolated from the primary winding. In another embodiment, the output terminals are electrically isolated from the primary winding and from one another. In embodiments in which two or more secondary windings are provided, each of the secondary windings may be coupled to two or more output terminals.

In an embodiment, the circuit is used to provide an auxiliary voltage. This auxiliary voltage may be used in an auxiliary system, for example the auxiliary voltage may be supplied to an inverter. For example, the inverter may be used in a control system for controlling an electric motor. The electric motor may be used in an aircraft, e.g., in a propulsion drive of an aircraft or a propulsion hybrid drive of an aircraft or in an auxiliary drive of an aircraft. The aircraft may be a fixed-wing airplane, for example. The circuit may be used for any type of isolated power transmission in auxiliary power applications or low power applications.

The invention also provides a method of producing a transformer for use at cryogenic temperatures. The method comprises providing a soft magnetic material for a core of the transformer, the soft magnetic material comprising a relative permeability at 77K, µᵣᵣcoil former and forming at least one secondary winding on a coil former, or, for a planar transformer, forming at least one primary winding on or in a circuit board, e.g., printed circuit board, and forming at least one secondary winding on or in the circuit board.

In an embodiment, the soft magnetic material comprises a manganese zinc ferrite, e.g., an oxide made from iron, manganese and zinc, such as N87.

In an embodiment, the forming the core from the material comprises providing the material in powder form, pressing the powder to form a green body and sintering the green body to form a sintered ferrite core.

The method may also comprise electrically isolating the primary winding and secondary winding. The secondary windings may be coupled to two or more output terminals. The output terminals may be electrically isolated from one another. In embodiments in which two or more secondary windings are provided, each of the secondary windings may be coupled to two or more output terminals.

The primary winding(s) and secondary winding(s) may be electrically isolated from one another. The output terminals of one secondary winding may be electrically isolated from one another and from the output terminals coupled to the other secondary windings.

Two or more primary windings may have the same potential and two or more secondary windings may have the same potential. In these embodiments, the primary winding(s) are electrically isolated from the secondary winding(s).

The invention solves problems coming with cryogenic temperature operation including:
reduction of the permeability µr which leads to low inductance;
low saturation currents of small nanocrystalline and amorphous cores;
high weight and large size of nanocrystalline and amorphous cores compared to ferrite cores for low power transformers;
high winding effort as there are no standard coil formers for multi-output transformers for use with nanocrystalline and amorphous cores available;
high isolation effort as nanocrystalline and amorphous cores are usually not isolated.

### BRIEF DESCRIPTION OF THE DRAWINGS

Embodiments will now be described with reference to the figures in which:

FIGS. 1A – 1D illustrate views of E-shaped cores for use in a transformer operating in a circuit at cryogenic temperatures.

FIG. 2A schematically illustrates a transformer in a circuit in accordance with the principles of the present invention.

FIG. 2B schematically illustrates another embodiment of a transformer according to the principles of the present invention.

FIG. 3 schematically illustrates an aircraft in which the present invention may be utilized.

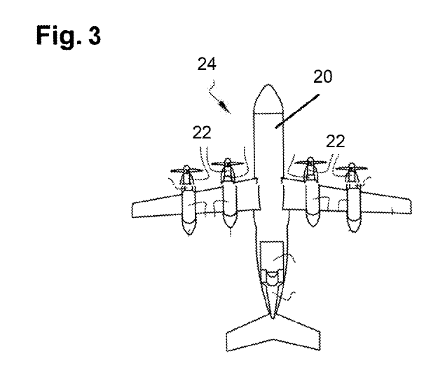

The invention addresses the issue of the impact of the temperature-dependent reduction in relative permeability µᵣ of the soft magnetic core of a transformer, that is caused by the cryogenic temperatures, on the effective inductance value of the transformer. This impact is mitigated according to the invention by including an air gap in the core. This air gap is not temperature sensitive. Consequently, the impact of the reduction of the relative permeability, µᵣ, of the core material on the overall inductance is lowered because the air gap shows a high percentage of the complete magnetic loop resistance.

### DETAILED DESCRIPTION OF THE PREFERRED EMBODIMENTS

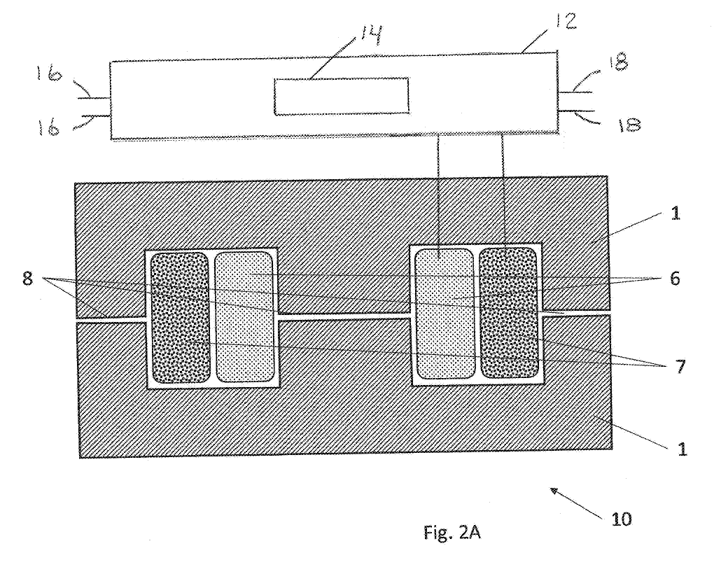

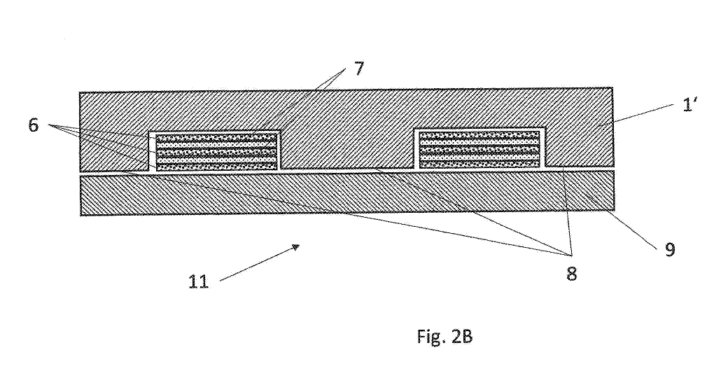

As shown in FIGS. 2A and 2B, a transformer 10,11 for use at cryogenic temperatures is provided. The transformer 10,11 comprises a ferrite core 1,1’ with an air gap 8 and comprises a relative permeability at 77K, µᵣᵣ (77K), wherein 50 ≤ µr (77K) ≤ 1000, with at least one primary winding 6 and at least one secondary winding 7.

A sufficiently high µᵣ value is provided for the intended application by suitably selecting the soft magnetic material of the core 1,1’, for example by suitably selecting a soft magnetic ferrite material. The value of the high temperature µr of the core material is less important than the lower (residual one) at cryogenic temperatures. This enables the use of ferrite materials in a cryogenic environment and the design of small, lightweight and easy-to-mount transformers 10,11 based on ferrite materials. Higher specific magnetic losses at cryogenic temperatures are less important because of the lower mass of small ferrite cores compared to the smallest nanocrystalline or amorphous ones. Coil formers for isolated transformers and some available transformer components for the industry and automotive temperature range are applicable again because the cores are applicable again according to the approach.

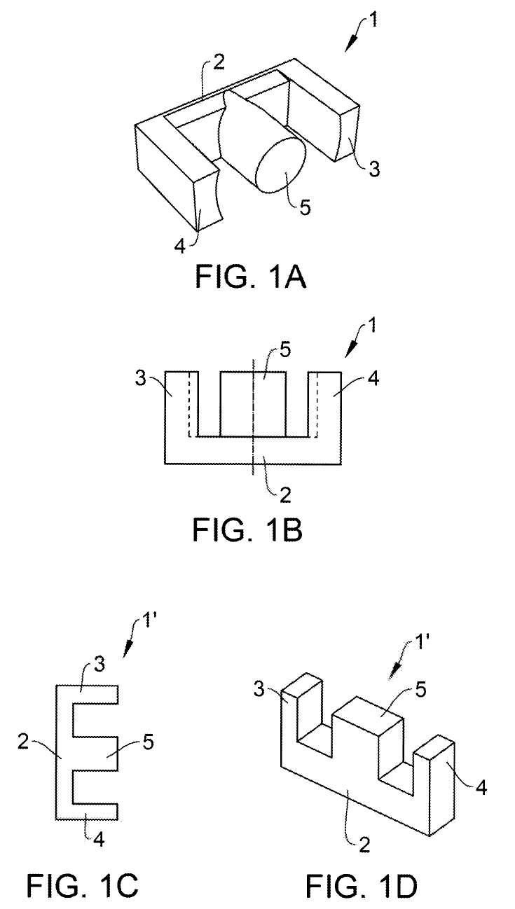

FIGS. 1A to 1D illustrate views of ferrite cores 1 for use in a transformer operating in a circuit at cryogenic temperatures, i.e., in a temperature range of 2K to 230K. The topology of the core 1 may be selected depending on the operating temperature range. The cores illustrated in FIGS. 1A – 1D are examples of cores 1 that may be fabricated using the principles of the present invention. Other types of cores may be used.

FIG. 1A illustrates a perspective view and FIG. 1B illustrates a side view of an E-shaped core 1 according to a first embodiment. The E-shaped core 1 includes a base portion 2, and two distal portions 3, 4 which extend from opposing distal ends of the base portion 2 and from the same side of the base portion 2. A center portion 5 extends from this side of the base portion 2 and is positioned approximately equidistantly between the two distal portions 3, 4 to form the E-shape. In this embodiment, the base portion 2 and the distal portions 3, 4 have a rectangular cross-section and the center portion 5 has a circular cross-section. The diameter of the center portion 5 is greater than the width and approximately the same as the breadth of the distal portions 3, 4.

In an embodiment, two of these E-shaped cores 1 may be used to form a transformer core with an air gap. In an alternative embodiment, one E-shaped core part 1 is used with a planar core part to provide a core for a planar transformer which has an air gap between the E-shaped core part 1 and the planar core part.

In an embodiment, the core 1 comprises an air gap 8 that is formed in the center portion 5 of the core. This air gap 8 may be ground into the center portion 5 of the core 1. In another alternative embodiment, two or more air gaps 8 are distributed throughout the core 1. This embodiment may be used for higher power. These distributed air gaps 8 are preferred for tolerance reasons. Distributed air gaps 8 may be used for larger cores 1.

FIG. 1C illustrates a side view and FIG. 1D illustrates a perspective view of an E-shaped core 1’ according to a second embodiment. Similar to the first embodiment, the E-shaped core 1’ includes a base portion 2, and two distal portions 3, 4 which extend from opposing distal ends of the base portion 2 and from the same side of the base portion 2. A center portion 5 extends from this side of the base portion 2 and is positioned approximately equidistantly between the two distal portions 3, 4 to form the E-shape. In the second embodiment, the center portion 5 as well as the base portion 2 and the distal portions 3, 4 have a rectangular cross-section. The width of the center portion 5 is greater than the width of the distal portions 3, 4. The breadth of the center portion 5 is approximately the same as the breadth of the distal portions 3, 4.

In an embodiment shown in FIG. 2A, two of these E-shaped cores 1 may be used to form the core of a transformer 10 with an air gap 8 in the two E-shaped cores 1. In an alternative embodiment shown in FIG. 2B, one E-shaped core 1’ is used with a planar core 9 to provide a core for a planar transformer 11 which has an air gap 8 between the E-shaped core 1’ and the planar core 9. A planar transformer may also be formed with two E-shaped cores, and many other core shapes are known to a person skilled in the art, all of which core shapes may selectively be used in carrying out the present invention.

The transformer core 1, 1’ of any one of the embodiments described herein may comprise a soft magnetic ferrite material. An example of a ferrite material group is manganese zinc ferrites. An example of a manganese zinc ferrite is MnₐZn(1-a)Fe₂O₄. A further example of a suitable manganese zinc ferrite is commercially available under the trade name N87.

For example, N87 typically decreases its relative permeability µr from the datasheet value 2200 at room temperature to a value in the range of 200 to 400 at cryogenic temperatures, e.g., at 70 to 100K. This relative permeability is suitable for a transformer core with an air gap which is to be used in a circuit operating at cryogenic temperatures.

Other types of ferrite materials may be used. For example, nickel-zinc-ferrites, e.g., with a composition of NiₐZn₍₁₋ₐ)Fe₂O_{4.} Proper selection of the core material and careful design lead to optimized performance of the transformer for a cryogenic environment. Manganese zinc ferrites typically have a higher permeability and a higher saturation magnetization than nickel zinc ferrites. The electrical conductivity of nickel zinc ferrites is lower than that of manganese ferrites so that nickel zinc ferrites are suitable for higher frequency applications.

Taking advantage of the values of the cryogenic µᵣ(77K) of a ferrite material, results in a transformer design which is much more compact and lightweight as a pure air core design and comes with much lower turns count of the winding to show the same inductance. Also, interwinding capacitances and copper losses are minimized. The overall transformer performance in a cryogenic environment is optimized by applying the right principles for the magnetic design according to the operating temperature.

Due to the provision of an air gap 8 in the ferrite transformer core1, 1’, the primary current ripple and the leakage inductance of a transformer is slightly higher at cryogenic temperatures than that achievable at room temperature due to the lower inductance. Also, the secondary voltage is less stiff because of the lower coupling factor (coupling of primary side to secondary side).

To summarize, the invention provides an approach to minimize the impact of µr degradation of (ferrite) materials in cryogenic temperatures on the overall primary inductance of the transformer 10, 11 while using the residual µr of the core 1, 1’ to ensure sufficient minimal inductance. The invention also provides an approach for a cryo-suitable auxiliary transformer 10, 11 with isolated multiple outputs, high isolation voltage and low coupling capacitance. The invention also enables the use of industrial COTS ferrite parts and coil formers for the design to minimize size and weight for a component in the low power (auxiliary supply) range.

The invention also provides for the use of the transformer 10, 11 of any one of the embodiments described herein in a circuit 12 operating at cryogenic temperatures in the range of 2K to 230K, preferably 25K to 150K.

The invention also provides for the use of the transformer 10, 11 of any one of the embodiments described herein in a circuit 12 operating at temperatures in the range of 25K to 373K.

The circuit 12 may have different topologies. In some embodiments, the circuit comprises a device 14 such as an inverter or an AC/AC converter or a power supply or a DC/DC converter or an AC/DC converter or an AC/DC converter with signal transmission. The circuit 12 may be used in applications comprising potential separated information transmission or potential separated energy transmission.

In some embodiments, the circuit 12 is configured to operate at a frequency in the range of 1 kHz to 900 kHz, preferably 100 kHz to 200 kHz. In an embodiment, the circuit 12 is used as an auxiliary power supply and is configured to operate at a frequency in the range of 100 kHz to 200 kHz.

In some embodiments, the circuit 12 comprises multiple outputs 16. Two or more of the multiple outputs 16 may be coupled to a single primary winding 6 or to more than one primary winding 6.

The primary winding 6 and secondary winding 7 are electrically isolated from one another. The secondary windings 7 may be coupled to two or more output terminals 18. The output terminals 18 are electrically isolated from the primary winding 6. In another embodiment, the output terminals 18 are electrically isolated from the primary winding 6 and from one another. In embodiments in which two or more secondary windings 7 are provided, each of the secondary windings may be coupled to two or more output terminals 18.

In an embodiment, the circuit 12 is used to provide an auxiliary voltage. This auxiliary voltage may be used in an auxiliary system, for example the auxiliary voltage may be supplied to an inverter. For example, the inverter may be used in a control system 20 for controlling an electric motor 22. The electric motor 22 may be used in an aircraft 24, e.g., in a propulsion drive of an aircraft 24 or a propulsion hybrid drive of an aircraft or in an auxiliary drive of an aircraft. The aircraft 24 may be a fixed-wing airplane, for example. The circuit 12 may be used for any type of isolated power transmission in auxiliary power applications or low power applications.

The systems and devices described herein may include a controller, control unit, control device, controlling means, system control such as control system 20, processor, computing unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 E-shaped core according to a first embodiment

1’ E-shaped core according to a second embodiment

2 base portion

3 distal end

4 distal end

5 center portion

6 primary winding

7 secondary winding

8 air gap

9 planar core part

10 transformer

11 planar transformer

12 circuit

14 device

16 output

18 output

20 control system

22 electric motor

24 aircraft

1. A transformer for use at cryogenic temperatures, the transformer comprising:
a ferrite core with an air gap and comprising a relative permeability at 77K, µᵣ(77K), wherein 50 ≤ µᵣ (77K) ≤ 1000;
at least one primary winding; and
at least one secondary winding.

2. The transformer according to claim 1, wherein the ferrite core comprises first and second parts with an air gap.

3. The transformer according to claim 1, wherein the ferrite core comprises a soft magnetic ferrite.

4. A circuit operating at cryogenic temperatures in the range of 25K to 100K comprising a transformer of claim 1.

5. The circuit according to claim 4, wherein the circuit comprises an inverter or an AC/AC converter or a DC/DC converter or a AC/DC converter with signal transmission or configured for an application comprising potential separated information transmission or potential separated energy transmission.

6. The circuit according to claim 4, wherein the circuit operates at a frequency in a range of 100 kHz to 200 kHz.

7. The circuit according to claim 4, wherein the circuit supplies multiple electrically isolated output voltages.

8. The circuit according to claim 4, wherein the circuit provides an auxiliary voltage configured to be useable in an inverter.

9. The circuit according to claim 8, wherein the inverter forms part of a control system for a propulsion drive or an auxiliary drive of an aircraft.

10. A method of producing a transformer for use at cryogenic temperatures, the method comprising:
providing a soft magnetic material for a core of the transformer, the soft magnetic material comprising a relative permeability at 77K, µᵣ(77K), wherein 50 ≤ µᵣ (77K) ≤ 1000, wherein the soft magnetic material comprises a soft magnetic ferrite,
forming the core from the soft magnetic material, the core having an air gap;
forming at least one primary winding on a coil former, or in a circuit board; and
forming at least one secondary winding on a coil former or in a circuit board.
